(19) United States
(12) Patent Application Publication
(10) Pub. No.: US 2023/0330755 A1
(43) Pub. Date: Oct. 19, 2023

(54) TOOL

(71) Applicant: PLUMBINGENUITY LIMITED, London (GB)

(72) Inventor: Tyrone Harnett, Devon (GB)

(21) Appl. No.: 18/028,839

(22) PCT Filed: Mar. 11, 2021
(86) PCT No.: PCT/EP2021/056254

§ 371 Date: Mar. 28, 2023

(30) Foreign Application Priority Data
Apr. 23, 2020 (GB) 2005991.1
Dec. 17, 2020 (GB) 2019945.1
Feb. 10, 2021 (GB) 2101834.6

(51) Int. Cl. B23B 51/00

(52) U.S. Cl. CPC B23B 51/0007

(57) ABSTRACT

A tool is described comprising a first part (14) adapted to be received by a part of a power tool, in use, and a second part (20) adapted to cooperate, in use, with a core drill bit (12), the first and second parts (14, 20) being releasably couplable to one another by a releasable coupling including a coupling pin (30) that, in use, extends within aligned passages (26, 28) formed in the first and second parts (14, 20), the coupling pin (30) including a resilient retainer clip section (32) that resiliently extends around at least part of, and engages, the first or second part (14, 20) to retain the coupling pin (30) in position. An arrangement in which a support member is carried by the second part is also described.

This invention relates to a tool, and in particular to an adapter whereby a core drill bit or diamond core hole cutting bit can be fitted to, for example, a power tool in the form of a power drill or the like.

Core drill bits and the like are in widespread use, being used in the drilling or formation of relatively large diameter holes or openings, for example of diameter in the range 38 mm to 127 mm, in walls or the like, for example in the installation of pipes, flues or vent ducts or the like. A typical core drill bit includes, at one end thereof, a threaded opening that, in use, is threadedly mounted upon an adapter which, in turn, is fitted to the chuck or the like of the power tool. After use, the core drill bit has to be unscrewed from the adapter, to allow the use of the adapter with a drill bit of a different size. The loadings and environment experienced, during use of the core drill bit in drilling a hole or opening, are such that it is fairly common for the drill bit to bind or become jammed upon the adapter, requiring the use of tools to apply sufficiently large loads to allow the drill bit to be unscrewed from the adapter. On occasion, in order to release the drill bit from the adapter, the user may hit the drill bit, for example with a hammer, which carries the risk of damage to the drill bit.

One further problem associated with the use of core drill bits is that, in use, the core of waste material formed using the drill bit is located within the central void of the drill bit and can become jammed within the void. Removal of the core from the void to allow subsequent use of the drill bit in the formation of another hole or opening can be problematic. Again, the user may hit the drill bit, for example using a hammer, in an attempt to dislodge the core, and this carries the risk of damaging the drill bit as mentioned hereinbefore.

There are a number of situations in which an existing opening formed in a wall or the like needs to be increased in diameter. By way of example, if modifications to equipment used within a building are made, then it may be required to install a flue, pipe or duct of an increased diameter, and the pre-existing opening may be of an insufficient diameter to accommodate such a flue, pipe or the like. Commonly, it is desirable for the increased diameter opening formed to accommodate the increased diameter flue, pipe or the like to be positioned coaxially with the original opening. It is an object of the invention to provide an alignment tool by which this may be achieved.

It is an object of the invention to provide a tool in which at least some of the disadvantages associated with known arrangements are overcome or are of reduced effect.

According to a first aspect of the invention there is provided a tool comprising a first part adapted to be received by a part of a power tool, in use, and a second part adapted to cooperate, in use, with a core drill bit, the first and second parts being releasably couplable to one another by a releasable coupling including a coupling pin that, in use, extends within aligned passages formed in the first and second parts, the coupling pin including a resilient retainer clip section that resiliently extends around at least part of, and engages, the first or second part to retain the coupling pin in position.

Such an arrangement is advantageous in that by release of the coupling, involving removal of the coupling pin, the first and second parts may be separated from one another. If the user possesses a set of second parts, these may be left secured to respective ones of his core drill bits. Accordingly, through the use of the invention, the need to use tools to apply loadings to release the core drill bit from the adapter is avoided, or required only when the core drill bits have become worn and require replacement.

Preferably, the first part includes an axial projection, received within an axial recess or passage formed in the second part. The projection and recess may both be of circular cross-sectional shape. However, this need not always be the case, and they may be of matching or complementary non-circular cross-sectional shapes with the result that the first and second parts may only be assembled to one another in a single relative orientation or in selected relative orientations. Furthermore, such an arrangement may assist in transmitting drive between the first and second parts.

The second part preferably contains an axial though passage extending over the complete length thereof. In use, a suitable core material removal tool may be introduced into the through passage and used to dislodge a core located within the core drill bit fitted to the second part. The core material removal tool conveniently comprises a rigid rod of a diameter slightly smaller than the minimum diameter of the through passage.

An end part of the through passage may be shaped to permit a tapered guide or centre pin to be fitted thereto. The second part may include a radial or diametrically extending passage adapted to allow a tapered drift key to be used in releasing or removing such a tapered guide or centre pin from the passage.

The design of the releasable coupling is advantageous in that it does not extend significantly beyond the outer diameter of the second part, and so does not significantly increase the overall diameter of the tool. Accordingly, it is suitable for use even where the core drill bit is of relatively small diameter. Furthermore, it does not result in the application of significant out of balance loads, and so does not place undue strain upon the power drill with which the invention is used or result in use of the power drill being impaired or impeded.

According to a second aspect of the invention there is provided a tool adapted to be received by a part of a power drill, in use, and to cooperate, in use, with a core drill bit, the tool containing an axial though passage extending over the complete length thereof. In use, a suitable core removal tool may be introduced into the through passage and used to dislodge a core located within the core drill bit fitted to the tool. The core removal tool conveniently comprises a rigid rod of a diameter slightly smaller than the minimum diameter of the through passage.

According to another aspect of the invention there is provided an alignment tool comprising a threaded support stub of relatively large axial length and with which a core bit is in threaded engagement, in use, and a support member secured to and in threaded engagement within the support stub, the support member including a section located within the core bit, in use, and a section projecting from the core bit, in use, the support member and the core bit, in use, being coaxial with one another.

The support member conveniently takes the form of a second core bit of smaller diameter than the above mentioned core bit. However as, in use, the support member is not intended to undertake a drilling function, but rather undertakes an alignment function, the support member may take other forms.

In use, a core bit of the appropriate size for the opening to be formed is fitted to the stub, and a support member of a diameter substantially matching the opening already formed in the wall or the like is fitted partially within the core bit. The assembly is fitted to a suitable power drill or the like. With part of the support member located within the opening already formed in the wall or the like, it will be appreciated that the support member will serve to guide and align the core bit, assisting the operator in using the assembly to drill an expanded diameter opening in the wall or the like, which is substantially coaxial with the original opening. It will be appreciated that once drilling of the expanded opening has commenced, a point will be reached at which the core bit is supported by the drilled part of the new opening. Once this point has been reached, the support member may be removed, if desired.

A lock nut conveniently in the form of a wing nut may be used to lock the support member to the shaft, in use, preventing or restricting rotation of the support member relative to the shaft and so preventing or restricting axial movement of the support member along the shaft. Whilst the use of a wing nut for this purpose functions well, the external diameter of a wing nut, and the space required to accommodate at least part of the users hand or fingers to allow tightening or release thereof, places restrictions upon the diameter of the support member, with the result that the arrangement may be difficult to use with a number of relatively small diameter support members.

Alternatively, and preferably, a helical spring may be positioned upon the support stub, the helical spring being compressed between the core bit and the support member.

In use the compression of the helical spring applies a load to the support member that tends to reducing binding or frictional resistance between the support member and the support stub, and so serves, in use, to allow the resistance to rotation of the support member as a result of its cooperation with the wall, to cause the support member to move axially upon the support stub until such time that the outer or larger core bit has contacted and scarred the wall. The support member can then be removed from the support stub with the scarring of the wall providing a guide for the completion of the formation of the opening in the wall. As the helical spring can be readily positioned over the support stub prior to attachment of the support member thereto, it will be appreciated that use of the invention is simple, and that the invention avoids the aforementioned issue of restricting the range of sizes of support member with which the invention can be employed.

Conveniently, the stub forms part of a tool as set out hereinbefore

The first and second parts of the tool conveniently include generally axially extending flow passages. The passages may be used to apply a vacuum, to remove dust generated during drilling, or may be arranged to conduct a flow of cooling fluid towards the core bit. As the pin could obscure such passages, the pin may be of reduced axial length so as to avoid forming a blockage. Alternatively, the pin may be formed with a passage that aligns with the flow passages to avoid forming such a blockage.

The first part may be of a range of shapes to enable the invention to be employed with a range of power tool designs. By way of example, the first part may include a hex shaped stub or may be of an sds design.

The invention further relates to a tool comprising a first part and a second part releasably securable to one another, the first and second parts being provided with openings that are alignable with one another, a lock pin being receivable within the openings to secure the first and second parts to one another, the first and second parts being provided with axially extending flow passages. The lock pin may be of a length such that it does not obscure the flow passages. Alternatively, it may be provided with one or more flow passages aligning, in use, with the flow passages formed in the first and second parts.

The invention will further be described, by way of example, with reference to the accompanying drawings, in which:

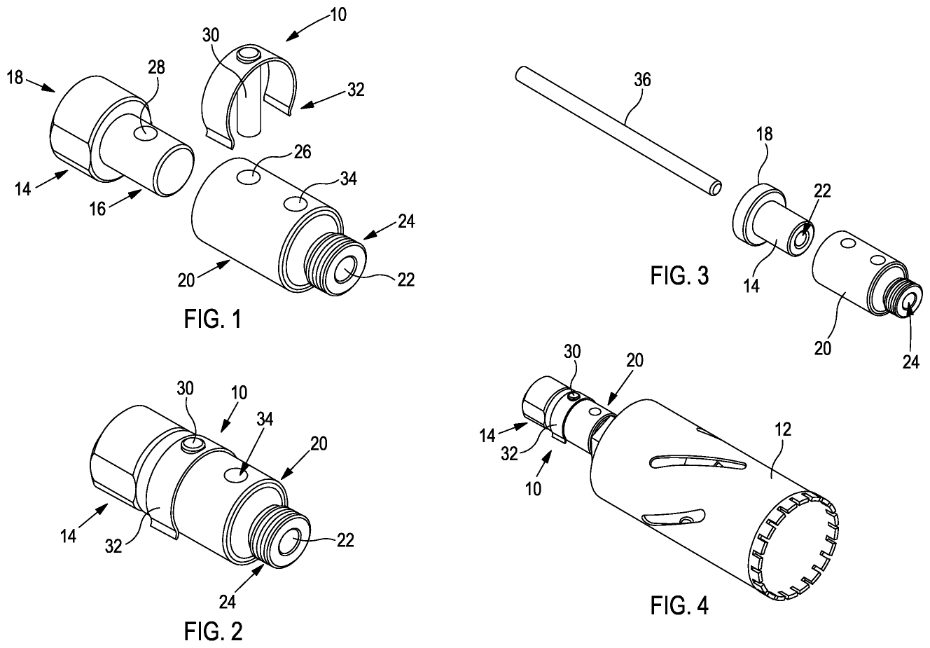

FIG. 1 is an exploded view of the tool of an embodiment of the invention;

FIG. 2 is an assembled view of the tool of FIG. 1;

FIG. 3 is a view illustrating the tool of FIG. 1, in use;

FIG. 4 is a further view illustrating the tool of FIG. 1;

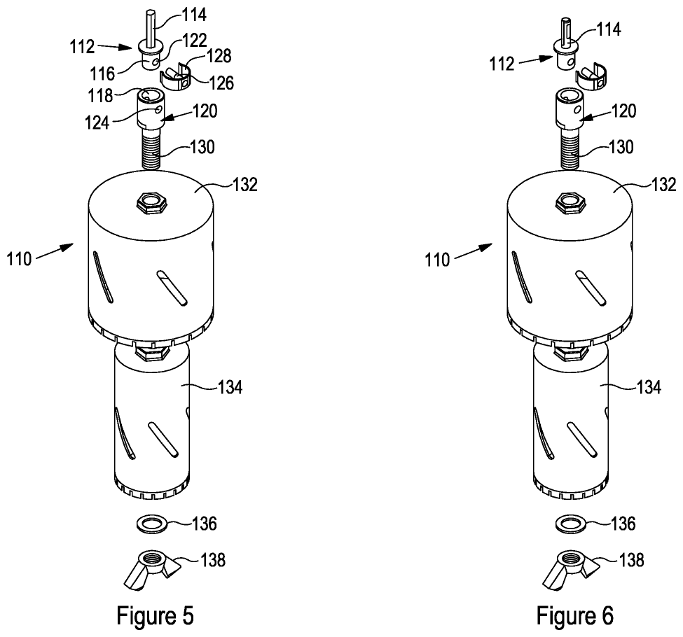

FIG. 5 is an exploded view illustrating an alignment tool in accordance with another embodiment of the invention;

FIG. 6 is a view showing an alternative embodiment;

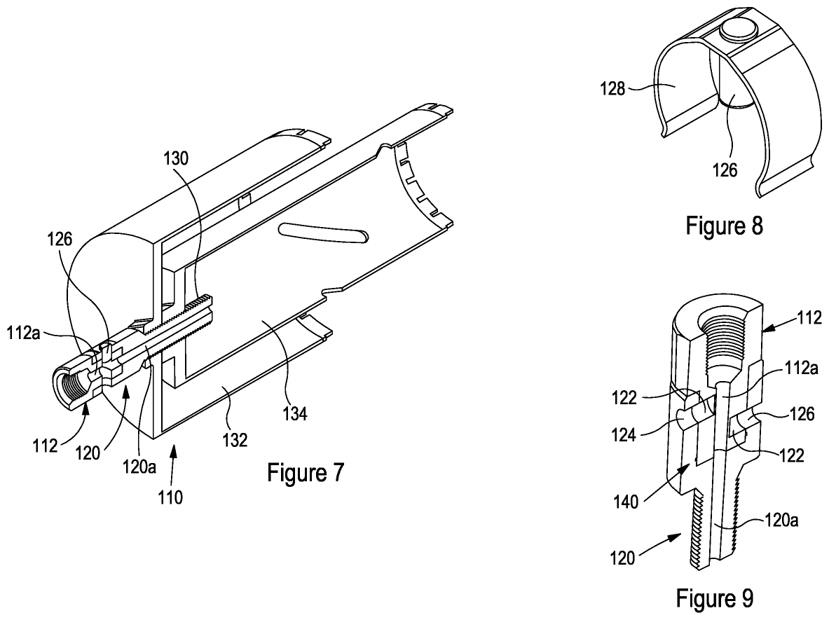

FIG. 7 is a sectional view illustrating a further embodiment;

FIG. 8 is an enlarged view illustrating part of the embodiment of FIG. 7;

FIG. 9 is a sectional view illustrating another embodiment; and

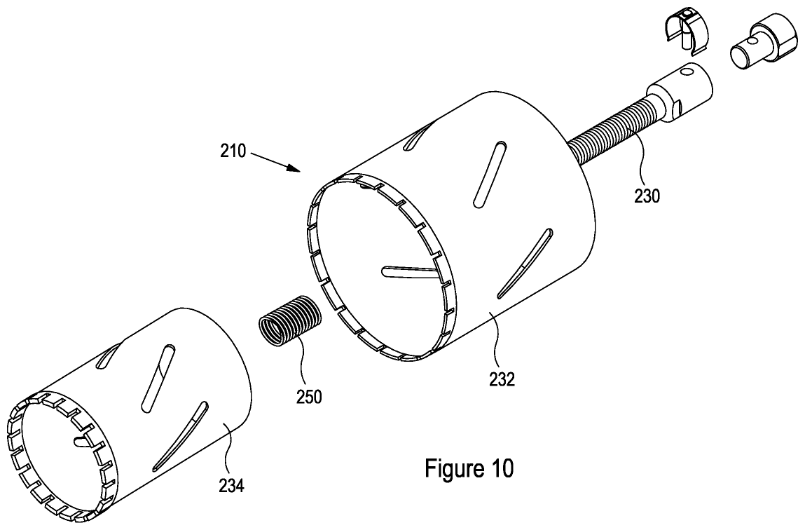

FIG. 10 is an exploded view illustrating a further embodiment of the invention.

Referring firstly to FIGS. 1 to 4 of the accompanying drawings, a tool 10 is illustrated, for use in the attachment of a core drill bit 12 to a power tool or the like (not shown). The tool 10 thus takes the form of a core bit adapter. The tool 10 comprises a first part or fitting 14 adapted to be secured to the chuck or the like of the power tool, the first part 14 being of stepped cylindrical form including a projection 16 of a reduced diameter, projecting or extending from a main section 18 adapted to be secured to the power tool. The precise form of the main section 18 will depend upon the nature of the power tool with which the tool 10 is to be fitted, and the invention is not restricted to any particular shape of the main section 18, but rather covers any shape of main section 18 suitable for use in attachment of the first part 14 to a power tool in such a manner as to permit the first part 14 to be rotated at high speed about its axis.

The tool 10 further comprises a second part or adapter 20 adapted to be releasable coupled to the first part 14. The second part 20 is of generally cylindrical shape and includes an axial through passage 22 of stepped diameter extending completely through the second part 20. At one end, the second part 20 includes a reduced diameter, externally threaded section 24 for threaded coupling to the core drill bit 12.

The end of the passage 22 remote from the threaded section 24 is of a relatively large diameter, substantially matching the dimeter of the projection 16, thereby allowing the second part 20 to be fitted onto the projection 16 and so allowing the first and second parts 14, 20 to be assembled to one another. The second part 20 is formed with a diametrically extending passage 26, and a corresponding diametrically extending passage 28 is formed in the projection 16, the passages 26, 28 being positioned such that upon assembly of the first and second parts 14, 20, the passages 26, 28 can be aligned with one another. A coupling pin 30 can then be introduced into the aligned passages 26, 28 to securely couple the first and second parts 14, 20 to one another.

The coupling pin 30 is preferably of a diameter substantially matching the diameters of the passages 26, 28 so that there is little play between the coupling pin 30 and the first and second parts 14, 20, when assembled. As illustrated, the coupling pin 30 includes a resilient C-shaped spring clip 32 that, when the first and second parts 14, 20 are assembled to one another and the coupling pin 30 is fitted thereto, extends around part of the second part 20 to retain the coupling pin 30 in position. In the arrangement shown, the coupling pin 30 extends from a central part of the spring clip 32, but it will be appreciated that this need not always be the case and that the pin 30 could be otherwise located, for example attached to an end part of the spring clip. The nature of the releasable coupling so formed is advantageous in that the coupling pin 30, when fitted, does not extend significantly beyond the outer diameter of the second part 20, and so does not significantly impact upon the range of sizes of core drill bits with which the invention may be used. Furthermore, it does not result in significant out of balance loads being experienced by the power tool, in use, which could negatively impact upon the operation thereof or may the task of drilling more difficult for the user.

The part of the passage 22 closest to the threaded section 24 may be of a cross-sectional shape adapted to allow the passage 22 to be used to receive a tapered guide rod or centre pin, in substantially a conventional manner, and a diametrically extending passage 34 may be provided in the second part 20 to allow the use of a convention tapered drift key or the like in the removal of such a tapered guide rod or centre pin.

In use, as shown in FIG. 4, a core bit 12 is threadedly mounted upon the threaded section 24 of the second part 20. When it is desired to use the core bit 12 in the formation or drilling of a hole or opening, the second part 20 is assembled to the first part 14 by introducing the projection 16 of the first part 14 into the large diameter end of the passage 22 of the second part 20 and, once the passages 26, 28 are aligned with one another, fully introducing the coupling pin 30 into the aligned passages 26, 28 so that the clip 32 extends around a majority of the second part 20 and serves to retain the coupling pin 30 in position. With the first part secured to the power tool, it will be appreciated that the tool 10 and core drill bit 12 mounted thereto may be driven for rotation.

A tapered guide rod or centre pin may be introduced into the end part of the passage 22 closest to the threaded section 24.

By introducing the guide rod or centre pin into a pilot hole drilled into the wall in the location at which the hole or opening is to be formed, the power tool and core drill bit may be used in substantially the usual manner to form the opening or hole, the guide rod or centre pin typically being removed from the passage 22 using a tapered drift key after drilling or an initial part of the hole or opening.

Upon completion of drilling, the tool 10 and core drill bit 12 may be removed from the power tool, and a core removal tool 36 in the form of a stiff rod, for example of a suitable metallic material, introduced into the passage 22. It will be appreciated that by applying a suitable load to the tool 36, the core of wall material that may still be located within the core drill bit 12 may be dislodged. If required, hammering or knocking of the core removal tool 36 may be undertaken to dislodge the core, without risk of damaging or denting the core drill bit 12.

The passage 22, in addition to aiding removal of a core of wall material, may further be used to apply a vacuum or suction to draw dust or the like produced in use away for collection and/or may be used for cooling purposes as described below.

Separation of the first and second parts 14, 20, to detach the core drill bit 12 from the first part 14, simply requires release and removal of the coupling pin 30 from the second part 20, after which the second part 20 can be slid off of the projection 16.

It is envisaged that the user will have a set of second parts 20, each left attached to respective ones of his core drill bits 12, may so the need to unscrew core drill bits 12 on a regular basis, with the attendant need to use tools and risk of causing damage to the core drill bits 12, is avoided.

If desired, an extender may be attached in substantially the same manner as set out hereinbefore, between the first and second parts 14, 20, where holes or openings of great depth are to be drilled.

Whilst in the arrangement described hereinbefore, and as illustrated in the accompanying drawings, uses a projection 16 and passage 22 of circular cross sectional shape, it will be appreciated that this need not always be the case and that these parts may be of complementary non-circular shapes, if desired. This may have the benefit of assisting in the transmission of torque loadings between the first and second parts 14, 20, and assisting is assembly of the tool 10. However, it may result in parts of the tool 10 being of reduced wall thickness, potentially reducing the load transmitting capacity thereof, and so may be undesirable in some circumstances.

The nature of the coupling between the first and second parts 14, 20 may be reversed, if desired, with the projection provided on the second part.

Referring next to FIG. 5, an alignment tool 110 is illustrated, comprising a fitting 112 having, in this case, a hex stub 114 for receipt by a power tool such as a power drill (not shown), the fitting 112 including a generally cylindrical body 116 adapted to be received, at least in part, within a correspondingly shaped cavity 118 provided in an adapter 120. The adapter 120 and fitting 112 are both formed with radially extending openings or passages 122, 124 which can align with one another when the cylindrical body 116 is located within the cavity 118. A lock pin 126 can be inserted into the aligned passages 122, 124 to secure the fitting 112 and adapter 120 to one another, and to transmit rotary drive therebetween. The lock pin 126 is secured to a spring clip 128 that, in use, clips around part of the adapter 120 to retain the lock pin 126 in position.

The adapter 120 includes a relatively long, axially extending threaded stub 130 onto which a core bit 132 can be secured.

With the exception of the length of the stub 130, it will be appreciated that the arrangement described above is very similar to the arrangement described hereinbefore with reference to FIGS. 1 to 4, and is used and has the benefits substantially as set out hereinbefore.

In accordance with this embodiment of the invention, a support member 134, in this case in the form of a second core bit, is also secured to the stub 130, the support member 134 being located partially within the core bit 132, but also including a part that projects from the core bit 132. The axial position of the support member 134 may be selected by the user by threading the support member 134 onto the stub 130 by a selected distance. Once positioned upon the stub 130 at the desired position, a washer 136 and a lock nut in the form of a wing nut 138 are introduced onto the stub 130 and tightened against the support member 134 to resist rotation of the support member 134 relative to the stub 130, and prevent or restrict relative movement between the support member 134 and the stub 130. Rather than use a wing nut to lock the support member 134 in position, other forms of nut may be used for this purpose, but may require a tool to be used to fasten such nuts in position.

The position on the stub 130 at which the support member 134 is located and locked in position using the wing nut 138 may be such that the support member 134 projects from the core bit 132 by a relatively large distance, being mounted close to the free end of the stub 130, if desired. Such an arrangement may be advantageous where the wall in which the opening is being formed is irregular, and having the support member 134 projecting by only a small distance may be inadequate to provide the required support and guidance. Of course, where desired, the support member 134 may project from the core bit 132 by only a small distance.

In use, in order to expand the diameter of an opening already formed in a wall or the like, a core bit 132 of the diameter of the required opening is fitted onto the stub 130. A support member 134 in the form of a second core bit of a diameter substantially matching the pre-existing opening is then fitted onto the stub 130 and secured in position using the wing nut 138. With the assembly fitted to a suitable power tool, and with the support member 134 extending into the pre-existing opening, the power tool can be used to drive the core bit 132 for rotation, to cut into the wall or the like and form the opening to the required diameter, the core bit 132 being positioned and guided by the cooperation between the support member 134 and the pre-existing opening.

Once formation of the opening is underway, the core bit 132 will be supported and guided by its engagement with the opening being formed, and so the support member 134 may be removed by releasing the wing nut 138 and unthreading the support member 134 from the stub 130.

It will be appreciated that the use of the alignment tool described hereinbefore provides a relatively simple, quick and efficient technique for forming an enlarged opening aligned with a pre-existing opening. The core bit 132 and support member 134 do not move significantly relative to one another, during drilling, and so provide a good, stable, level of support, despite being subject to high rotary speeds and significant levels of vibration, in use.

Although the use of a second core bit as the support member 134 is described hereinbefore, it will be appreciated that the primary function of the support member 134 is in supporting the core bit 132 in the correct position, not in performing a drilling function. An appropriately sized and shaped support member 134 that does not include drill teeth or the like may thus be used, if desired.

In the arrangement described hereinbefore, the fitting 112 includes a hex stub 114 for receipt by the power tool. It will be appreciated that the fitting 112 may be of other shapes for use with other forms of power tool, and FIG. 6 illustrates a modification to the arrangement of FIG. in which the stub 114 is of an sds form. With the exception of the design of the stub 114, the arrangement of FIG. 6 is substantially the same as that of FIG. 5.

FIGS. 7 and 8 illustrate another embodiment, in this case in which the fitting 112 is provided with a threaded passage for cooperation with a power tool.

A further difference between the arrangement of FIGS. 7 and 8 and the arrangements of FIGS. 5 and 6 is that the fitting 112 and adapter 120 are provided with axially extending flow passages 112a, 120a that may be used, for example to allow a vacuum device or the like to draw dust generated during drill away from the core bit 132, for example for suitable collection, as mentioned hereinbefore. Alternatively, the passages 112a, 120a may be used to conduct a cooling fluid towards the core bit 132. As a lock pin 126 of the length shown in FIGS. 5 and 6 would obstruct the passages 112a, 120a and interfere with operation, as shown in FIGS. 7 and 8 a reduced length lock pin 126 may be used. An alternative to using a reduced length lock pin 126 may be to form a suitably positioned and orientated diametrical passage in the lock pin 126. Where a reduced length pin 126 is used, it may be possible to provide two or more such pins located to opposite sides of the adapter 120, if desired.

Where the arrangement of FIGS. 7 and 8 is used to conduct a cooling fluid towards the core bit, there is a risk that some of the coolant fluid may escape between the fitting 112 and the adapter 120, and/or along and through the openings or passages 122, 124. FIG. 9 illustrates an embodiment in which this disadvantage is obviated through the inclusion of a seal member in the form of an O-ring 140 located between the fitting 112 and the adapter 120, conveniently carried by the fitting 112, and by forming the openings or passages 122 in the fitting 112 as blind bores that do not extend into the flow passage 112a. It will be appreciated that the arrangement of FIG. 9 may also be beneficial where suction is applied to extract drilling dust, and the ingress of air between the fitting 112 and adapter 120 and along the openings or passages 122, 124 may be reduced, and so the consequent reduction in suction may be avoided.

In the arrangement shown in FIG. 9, a pair of relative short lock pins 126 are used, the lock pins 126 and associated openings or passages 122, 124 being axially offset from one another.

The flow passages and other modifications of FIGS. 7 to 9 could be incorporated into the arrangements of FIGS. 5 and 6, if desired.

Referring to FIG. 10, another embodiment of an alignment tool 210 is illustrated. Other than as set out herein, the alignment tool 210 is substantially the same as, functions in the same manner as, and is employed in the same way as the alignment tool described and illustrated hereinbefore with reference to FIGS. 5 to 9.

The primary difference between the alignment tool 210 of FIG. 10 and those described hereinbefore relates to the manner in which the support member 234 is locked in position upon the support stub 230. The wing nut and washer of the arrangements shown in FIGS. 5 to 9 are omitted and, instead, a helical spring 250 is provided, the helical spring 250 being compressed in use, between the core bit 232 and the support member 234.

In use, after fitting the core bit 232 to the support stub 230 in the usual manner, the helical spring 250 is fitted onto and around the support stub 230. The support member 234 is then threaded onto the support member 230 in the usual manner, and it will be appreciated that the action of attaching and positioning the support member 234 onto the support stub 230 results in the helical spring 250 becoming compressed between the core bit 232 and the support member 234. This compression of the helical spring 250 applies an axially directed load to the support member 234 that, in use, results in a reduction in the frictional resistance to rotation between the support member 234 and the support stub 230. Consequently, in use, the frictional resistance to rotation between the support member 234 and the wall, in combination with the effect of the provision of the spring 250, will result in the support member 234 being able to move axially upon the support stub 230 and so enabling contact between the core bit 232 and the wall, commencing the formation of the required opening in the wall. After scarring or commencement of the formation of the opening in this manner, the support member 234 can be removed from the support stub 230 with the spring 250 again reducing binding of the support member 234 upon the stub 230, after which the core bit 232 can be used to complete the formation of the required opening in the usual manner.

It will be appreciated that as the need to use a wing nut or the like to lock the support member against rotation is avoided, the size limitations that arise with the arrangements described hereinbefore through the use of such a wing nut are avoided.

Whilst the arrangements of FIGS. 5 to 10 incorporate the scheme, or variations of the scheme, shown in FIGS. 1 to 4, it will be appreciated that this need not be the case and they could be employed in other applications. Their use is not restricted to arrangements in which the threaded stub forms part of an adapter releasably securable to a fitting using a pin. By way of example, the invention could be employed in applications in which the adapter is received directly by the power tool.

Whilst a specific embodiment of the invention is described hereinbefore, it will be appreciated that a number of modifications and alterations may the tool as hereinbefore described without departing from the scope of the invention as defined by the appended claims.

1. A tool comprising a first part adapted to be received by a part of a power tool, in use, and a second part adapted to cooperate, in use, with a core drill bit, the first and second parts being releasably couplable to one another by a releasable coupling including a coupling pin that, in use, extends within aligned passages formed in the first and second parts, the coupling pin including a resilient retainer clip section that resiliently extends around at least part of, and engages, the first or second part to retain the coupling pin in position.

2. The tool according to claim 1, wherein the first part includes an axial projection, received within an axial recess or passage formed in the second part.

3. The tool according to claim 2, wherein the projection and recess are both of circular cross-sectional shape.

4. The tool according to claim 1, wherein the second part contains an axial though passage extending over the complete length thereof.

5. The tool according to claim 4, and further comprising a core material removal tool introducible, in use, into the through passage to dislodge a core located within a core drill bit fitted to the second part, in use.

6. The tool according to claim 5, wherein the core material removal tool comprises a rigid rod of a diameter slightly smaller than the minimum diameter of the through passage.

7. The tool according to claim 4, wherein an end part of the through passage is shaped to permit a tapered guide or centre pin to be fitted thereto.

8. The tool according to claim 7, wherein the second part includes one of a radially extending passage and a diametrically extending passage, adapted to allow a tapered drift key to be used in releasing or removing such a tapered guide or centre pin from the passage.

9. The tool adapted to be received by a part of a power drill, in use, and to cooperate, in use, with a core drill bit to be provided, the tool containing an axial though passage extending over the complete length thereof.

10. The tool according to claim 9, and further comprising a core material removal tool introducible, in use, into the through passage to dislodge a core located within a core drill bit fitted to the tool, in use.

11. The tool according to claim 10, wherein the core material removal tool comprises a rigid rod of a diameter slightly smaller than the minimum diameter of the through passage.

12. An alignment tool comprising a threaded support stub of relatively large axial length and with which a core bit is in threaded engagement, in use, and a support member secured to and in threaded engagement within the support stub, the support member including a section located within the core bit, in use, and a section projecting from the core bit, in use, the support member and the core bit, in use, being coaxial with one another.

13. The alignment tool according to claim 12, wherein the support member takes the form of a second core bit of smaller diameter than the first mentioned core bit.

14. The alignment tool according to claim 12, wherein the stub forms part of an adapter that is removably securable to a fitting adapted to be received, in use, by part of a power tool.

15. The alignment tool according to claim 14, wherein the adapter and fitting form the first and second parts of a tool according to claim 1.

16. The alignment tool according to claim 12, and further comprising a lock nut to secure the support member in position.

17. (canceled)

18. The alignment tool according to claim 12, wherein a helical spring is positioned upon the support stub, the helical spring being compressed between the core bit and the support member.

19. The alignment tool according to claim 12, wherein the first and second parts include generally axially extending flow passages, wherein the pin is configured to avoid forming a blockage of the flow passages.

20-21. (canceled)

22. The alignment tool according to claim 12, wherein a seal member is located between the first and second parts.

23. A tool comprising a fitting and an adapter releasably securable to one another, the fitting and the adapter being provided with openings that are alignable with one another, a lock pin being receivable within the openings to secure the fitting and adapter to one another, the fitting and adapter being provided with axially extending flow passages.

24. The tool according to claim 23, wherein the lock pin is of a length such that it does not obscure the flow passages.

25. The tool according to claim 23, wherein the lock pin is provided with one or more flow passages aligning, in use, with the flow passages formed in the fitting and the adapter.

26. The tool according to claim 23, wherein a seal member is located between the fitting and the adapter.
